(19) United States
(12) Patent Application Publication
(10) Pub. No.: US 2015/0121546 A1
(43) Pub. Date: Apr. 30, 2015

(54) Device and Process for Restricting Access to Features on Electronic Devices Based on the Size of the Surface Area of the Finger and Other Factors

(71) Applicant: TracFone Wireless, Inc., Miami, FL (US)

(72) Inventor: Sze Ho Wong, Miami, FL (US)

(21) Appl. No.: 14/062,943

(22) Filed: Oct. 25, 2013

(51) Int. Cl. G06F 21/62; G06F 3/0484

(52) U.S. Cl. CPC G06F 21/629; G06F 3/0484
USPC 726/28

(57) ABSTRACT

An electronic device configured to restrict access to features includes a processor configured to execute instructions and a display device configured to generate an interface based in part in response to the processor. The electronic device further includes a touch screen associated with the display device and configured to sense a user input, wherein the input is provided to the processor, a memory configured to store the instructions to operate the electronic device, the processor further configured to determine at least one of a physical aspect of the user input and a user interaction with the electronic device, the processor further configured to execute a plurality of features associated with the electronic device, and the processor further configured to disable some of the features based on the determination of at least one of a physical aspect of the user input and a user interaction with the electronic device.

### BACKGROUND OF THE DISCLOSURE

1. Field of the Disclosure

This disclosure relates generally to a device and a process for restricting access to features on electronic devices. More particularly, the disclosure relates generally to a device and process for restricting access to features on electronic devices based on the size of the surface area of the finger and other factors.

2. Related Art

Many electronic devices have touch-based graphical user interfaces. These electronic devices can include wireless devices, mobile phones, tablet computers, gaming devices, MP3 players, and the like. Touch-based graphical user interfaces are a substantial improvement over prior approaches to providing input and display functions to electronic devices. Additionally, these electronic devices are often very entertaining for children as they often include the ability to play games, search the Internet, generate sound, place phone calls, play music, and the like. However, the owner of the electronic device may want to prevent or limit the usage or type of usage that the electronic device can provide to a child. For example, a parent may not want a child to place phone calls, send e-mails, search the Internet, play games, or the like on their electronic device. Some electronic devices include electronic locks that when activated, prevent all users from operating the electronic device until a password or personal identification number is entered into the electronic device to unlock the device. However, utilizing such an electronic lock can be bothersome for the user as it limits quick access to the electronic device. Additionally, a child may gain access to the electronic device prior to the electronic device being locked. Accordingly, the lock provides no restrictions on the usage by the child in such cases. Moreover, the typical electronic device lock will typically either completely prevent usage of the electronic device or provide very limited usage of the device (emergency phone calls, camera capabilities, or the like). There typically is no way to provide a customized limited usage of the electronic device. Finally, some electronic devices may not be implemented with an electronic lock.

Accordingly, there is a need for a device and process that will automatically limit usage of the electronic device by a child without being unduly burdensome to the user.

### SUMMARY OF THE INVENTION

The foregoing needs are met, to a great extent, by the invention, with a process and device for restricting access to features on electronic devices based on the size of the surface area of the finger and other factors.

In one aspect, an electronic device configured to restrict access to features includes a processor configured to execute instructions, a display device configured to generate an interface based in part in response to the processor, a touch screen associated with the display device and configured to sense a user input, wherein the input is provided to the processor, a memory configured to store the instructions to operate the electronic device, the processor further configured to determine at least one of a physical aspect of the user input and a user interaction with the electronic device, the processor further configured to execute a plurality of features associated with the electronic device, and the processor further configured to disable some of the features based on the determination of at least one of a physical aspect of the user input and a user interaction with the electronic device.

In another aspect of the invention, a process of restricting features of an electronic device includes generating an interface on a display device of an electronic device, sensing a user input on a touch screen associated with the display device and a user interaction with the electronic device, storing instructions to operate the electronic device in a memory, providing a plurality of features associated with the electronic device, determining at least one of a physical aspect of the user input and a user interaction with the electronic device, and disabling some of the features based on the determining at least one of a physical aspect of the user input and a user interaction with the electronic device.

In yet another aspect of the invention an electronic device configured to restrict access to features includes means for generating an interface on a display device, means for sensing a user input on a touch screen associated with the display device and a user interaction with the electronic device, means for storing instructions to operate the electronic device in a memory, means for providing a plurality of features associated with the electronic device, means for determining at least one of a physical aspect of the user input and a user interaction with the electronic device, and means for disabling some of the features based on the determining at least one of a physical aspect of the user input and a user interaction with the electronic device. In one or more aspects, an electronic device [to be completed by Baker Hostetler based on final claims].

There has thus been outlined, rather broadly, certain aspects of the invention in order that the detailed description thereof herein may be better understood, and in order that the present contribution to the art may be better appreciated. There are, of course, additional aspects of the invention that will be described below and which will form the subject matter of the claims appended hereto.

In this respect, before explaining at least one aspect of the invention in detail, it is to be understood that the invention is not limited in its application to the details of construction and to the arrangements of the components set forth in the following description or illustrated in the drawings. The invention is capable of aspects in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the invention. It is important, therefore, that the claims be regarded as including such equivalent constructions insofar as they do not depart from the spirit and scope of the invention.

### BRIEF DESCRIPTION OF THE DRAWINGS

FIG. 1 shows the details of an exemplary electronic device in accordance with aspects of the invention.

FIG. 2 shows a child with a smaller hand using the electronic device in accordance with aspects of the invention.

FIG. 3 shows a user with a larger hand using the electronic device in accordance with aspects of the invention.

FIG. 4 shows a child user determination process and process of limiting access to the electronic device in accordance with aspects of the invention.

FIG. 5 shows a child user profile in accordance with aspects of the invention.

### DETAILED DESCRIPTION

Reference in this specification to an electronic device is intended to encompass devices such as wireless devices, mobile phones, tablet computers, gaming systems, MP3 players and the like. Reference to a “wireless device” is intended to encompass any compatible mobile technology computing device that connects to a wireless communication network, such as mobile phones, mobile equipment, mobile stations, user equipment, cellular phones, smartphones, handsets or the like (e.g., Apple iPhone, iPad, Google Android based devices, BlackBerry based devices, other types of PDAs or smartphones), wireless dongles, or other mobile computing devices. The term “wireless device” may be interchangeably used and referred to herein as “wireless handset,” “handset,” “mobile device,” “device,” “mobile phones,” “mobile equipment,” “mobile station,” “user equipment,” “cellular phone,” “smartphones,” or “phone.”

Wireless devices may connect to a “wireless network” or “network” and are intended to encompass any type of wireless network to obtain mobile phone services through the use of a wireless device, such as the Global System for Mobile Communication (GSM) network, Code-Division Multiple Access (CDMA) network or the like, that may utilize the teachings of the present application to allow a wireless device to connect to a wireless network. More generally, the wireless devices may connect over a communication channel as defined herein.

Reference in this specification to “one aspect,” “an aspect,” “other aspects,” “one or more aspects” or the like means that a particular feature, structure, or characteristic described in connection with the aspect is included in at least one aspect of the disclosure. The appearances of, for example, the phrase “in one aspect” in various places in the specification are not necessarily all referring to the same aspect, nor are separate or alternative aspects mutually exclusive of other aspects. Moreover, various features are described which may be exhibited by some aspects and not by others. Similarly, various requirements are described which may be requirements for some aspects but not other aspects.

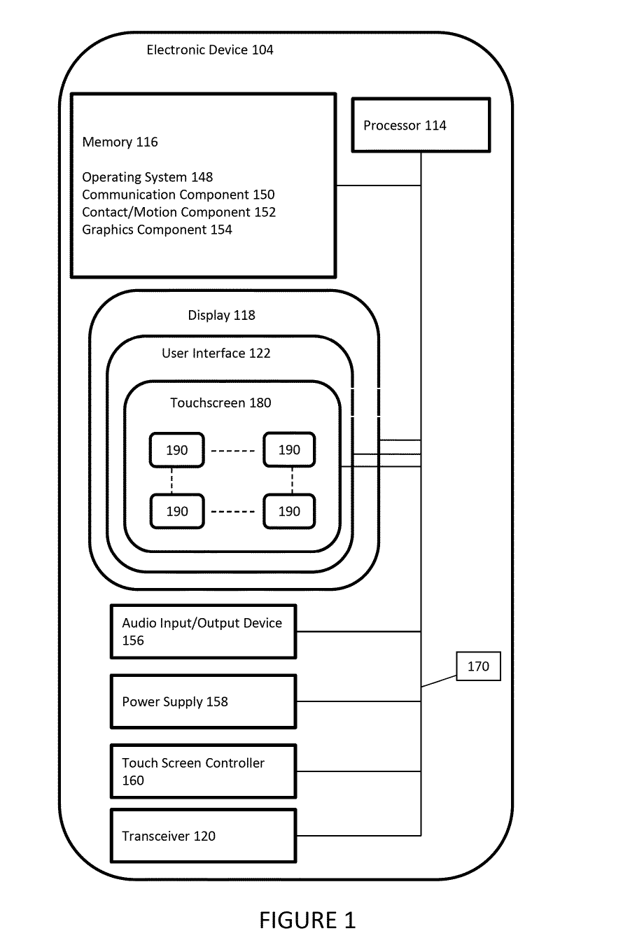

FIG. 1 shows the details of an exemplary electronic device in accordance with aspects of the invention. The electronic device 104 includes a processor 114, memory 116, display 118, user interface 122, and the like. The processor 114 may be a central processing unit configured to execute instructions including instructions related to software programs. The display 118 may be a liquid crystal display having a backlight to illuminate the various color liquid crystals to provide a colorful display. The user interface 122 may be any type of physical input having buttons and further may be implemented as a touchscreen 180.

The electronic device 104 may further include in the memory 116, an operating system 148, a communication component 150, a contact/motion component 152, a graphics component 154 and the like. The operating system 148 together with the various components providing software functionality for each of the components of the electronic device 104.

The memory 116 may include a high-speed random-access memory. Also, the memory 116 may be a non-volatile memory, such as magnetic fixed disk storage, flash memory or the like. These various components may be connected through various communication lines including a data bus 170.

Additionally, the electronic device 104 may include an audio input/output device 156. The audio input/output device 156 may include speakers, speaker outputs, and in the like, providing sound output; and may include microphones, microphone inputs, and the like, for receiving sound inputs. The audio input/output device 156 may include and analog to digital converter and a digital to audio converter for audio input and output functions respectively.

When implemented as a wireless device, the electronic device 104 may include a transceiver 120 and the like. The electronic device 104 may provide radio and signal processing as needed to access a network for services. The processor 114 may be configured to process call functions, data transfer, and the like and provide other services to the user.

Additionally, the electronic device 104 may include an inertial motion unit (IMU) 184. The IMU 184 may include one or more inertial sensors to determine motion of the electronic device 104. For example, the IMU 184 may include a plurality of sensors implemented as piezoelectric devices, load cells, strain gages or the like, for example, to sense acceleration and/or motion in one or more directions. More specifically, the IMU 184 may include 3 sensors to detect acceleration and/or motion in 3 different axes. Additionally, the IMU 184 may be further implemented to detect rotational movement about these three axes as well to provide six total degrees of motion detection. The IMU 184 may output the one or more degrees of acceleration and/or motion to the processor 114. Thereafter, the processor 114 may determine acceleration and/or motion of the electronic device 104.

The touchscreen 180 of the invention may be implemented in the display 118 and may detect a presence and location of a touch of a user within the display area. For example, touching the display 118 of the electronic device 104 with a finger or hand. The touchscreen 180 may also sense other passive objects, such as a stylus.

In operation, the display 118 may display various objects 190 associated with applications for execution by the processor 114. In this regard, a user may touch the display 118, and in particular the touchscreen 180, to interact with the objects 190. For example touching an object 190 may execute an application in the processor 114 associated with the object 190 that is stored in memory 116. Additionally or alternatively, touching an object 190 may open a menu of options to be selected by the user. The display 118 may include a plurality of the objects 190 for the user to interact with. Moreover the display 118 may include a plurality of screens. The display 118 showing one screen at a time. The user may interact with the display 118 to move a screen into view on the display 118. Various objects 190 may be located in the each of the screens.

The touchscreen 180 may be implemented as a resistive touchscreen, a surface acoustic wave touch screen, a capacitive touch screen, a surface capacitance touchscreen, projected capacitive touch screen, self-capacitance sensors, infrared sensors, dispersive signal technology, acoustic pulse recognition, or the like.

When the touchscreen 180 is implemented as a resistive touchscreen panel it may include several layers. It may include two thin, transparent electrically-resistive layers separated by a thin space. These layers may face each other, with a thin gap between. A top screen or the screen which experiences the users touch may have a coating on the underside surface of the touchscreen 180. Beneath this layer may be a similar resistive layer on top of its substrate. One layer may have conductive connections along its sides, the other along top and bottom. A voltage may be passed through one layer, and sensed at the other. When an object, such as a fingertip or stylus tip, presses down on the outer surface, the two layers touch to become connected at that point. Accordingly, the touchscreen 180 may then behave as a pair of voltage dividers, one axis at a time. By rapidly switching between each layer, the position of a pressure on the screen can be read.

The touchscreen 180 may be implemented with surface acoustic wave (SAW) technology. SAW technology may use ultrasonic waves that pass over the touchscreen 180. When the touchscreen 180 is touched, a portion of the wave may be absorbed. This change in the ultrasonic waves registers the position of the touch event and sends this information to the controller for processing.

The touchscreen 180 may be implemented with capacitive touchscreen panel. A capacitive touchscreen panel may include an insulator such as glass, coated with a transparent conductor such as indium tin oxide. As the user's body is also an electrical conductor, touching the surface of the screen results in a distortion of the screen's electrostatic field, measurable as a change in capacitance. The location is then sent to the processor 114 for processing. Only one side of the insulator may be coated with a conductive layer. A small voltage may be applied to the layer, resulting in a uniform electrostatic field. When a conductor, such as a human finger, touches the uncoated surface, a capacitor is dynamically formed. The processor 114 can determine the location of the touch indirectly from the change in the capacitance as measured from the four corners of the panel.

The touchscreen 180 may be implemented as a projected capacitive touch (PCT) device. The PCT touch screen may be made up of a matrix of rows and columns of conductive material, layered on sheets of glass. This can be manufactured either by etching a single conductive layer to form a grid pattern of electrodes, or by etching two separate, perpendicular layers of conductive material with parallel lines or tracks to form a grid. Current applied to this grid creates a uniform electrostatic field, which can be measured. When a conductive object, such as a finger, comes into contact with a PCT touchscreen, it distorts the local electrostatic field at that point. This is measurable as a change in capacitance. If a finger bridges the gap between two of the tracks, the charge field is further interrupted and detected by the processor 114. The capacitance can be changed and measured at every individual point on the grid.

The touchscreen 180 may be implemented with self-capacitance sensors. Self-capacitance sensors may have an X-Y grid with columns and rows that operate independently. With self-capacitance, the capacitive load of a finger is measured on each column or row electrode by a current meter.

The touchscreen 180 may be implemented with infrared sensors. Infrared sensors may be mounted around the display to sense for a user's touchscreen input. An infrared touchscreen may use an array of X-Y infrared LED and photodetector pairs around the edges of the screen to detect a disruption in the pattern of LED beams. These LED beams cross each other in vertical and horizontal patterns. Two or more image sensors are placed around the edges of the screen. Infrared back lights may be placed in a camera's field of view on the other side of the screen. A touch shows up as a shadow and each pair of cameras can then be pinpointed to locate the touch or even measure the size of the touching object.

The touchscreen 180 may be implemented with dispersive signal technology. Dispersive signal technology may use sensors to detect the piezoelectricity in the glass that occurs due to a touch. Algorithms executed by the processor 114 then interpret this information and provide the actual location of the touch.

The touchscreen 180 may be implemented with acoustic pulse recognition. In this aspect, a touch at each position on the glass generates a unique sound. Transducers attached to the edges of the touchscreen glass pick up the sound of the touch. The sound is then digitized by the processor 114 and compared to a list of prerecorded sounds for every position on the glass.

The electronic device 104 includes a system and process for determining when a user may be a child. The determination may be based on how the child uses the touchscreen 180, which objects 190 are used, how the child physically touches the touchscreen 180, and based on the sensed motion of the electronic device 104. When the electronic device 104 determines the user is a child, the electronic device 104 will operate based on a child user profile. Additionally, the electronic device 104 may include a setting that implements the child user profile in response to a manual setting by the user.

The manner in which it is determined that a user is a child can be based on interaction with the touchscreen 180. In this regard, it may be based on the sensed touching of the touchscreen 180. The touchscreen 180 may be configured to sense the touch of a user as noted above. This ability to sense the touch of the user may include being able to determine the size of the surface the user touches on the touchscreen 180. For example, a user with smaller fingers will be sensed by the touchscreen 180 in conjunction with the processor 114 as having a smaller physical contact surface. On the other hand, a user with larger fingers, a user that uses a larger surface of a finger, or the like, will be sensed by the touchscreen 180 in conjunction with the processor 114 as having a larger physical contact surface. This would be indicative of the user not being a child. Moreover, the touchscreen 180 in conjunction with the processor 114 may be configured to determine a more exact, an average, a median, or the like physical contact surface in order to determine how the user physically touches the touchscreen 180 in order to be able to determine a threshold contact surface size for comparison of future such determination. Accordingly, a user operating the electronic device 104 with a smaller physical contact surface may be determined to be a child and the electronic device 104 may operate in conjunction with the child user profile.

Similarly, a user who has a tendency to bounce their finger on or across the surface of the touchscreen 180, drag and/or slide their finger on the touchscreen 180 may be sensed as being a child. In this regard, previous interaction with the touchscreen 180 by a user may set predetermined values regarding bounce, slide, and other physical interactions. Further interactions with the touchscreen 180 outside these predetermined values, which may include a threshold value, may be determined to be consistent with use of the electronic device 104 by a child.

Additionally, contact by the user with electronic device 104 and touchscreen 180 that has a frequency and randomness above a predetermined threshold may be determined to be a child user as well. Finally, if the electronic device 104 is moved, shaken, carried, or the like with randomness and/or motion that is higher than a particular threshold or higher than previous sensed values, the electronic device 104 may determine the user to be a child. Accordingly, once the electronic device 104 determines that the user may be a child, the electronic device 104 may operate based on the child user profile.

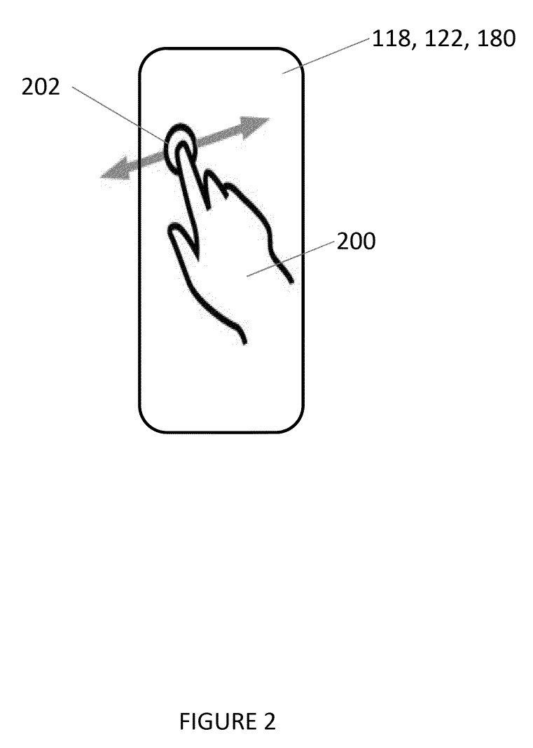

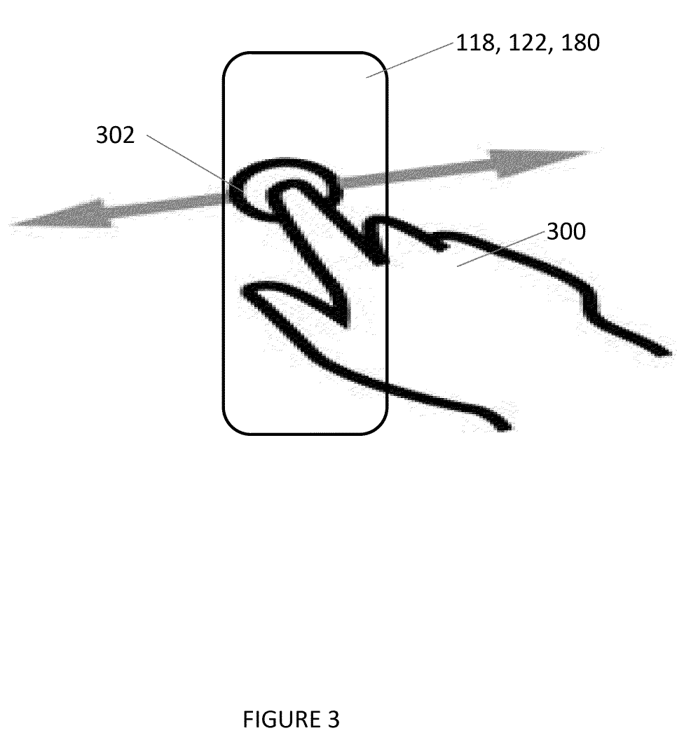

FIG. 2 shows a child with a smaller hand using the electronic device in accordance with aspects of the invention; and FIG. 3 shows a user with a larger hand using the electronic device in accordance with aspects of the invention. FIG. 2 shows a user hand 200 that is child sized or smaller than average sized. The resulting physical contact surface 202 on the display 118, user interface 122, and touchscreen 180 is of a first size. On the other hand, FIG. 3 shows a user hand 300 that is larger than a child. The resulting physical contact surface 302 on the display 118, user interface 122, and touchscreen 180 is of a second larger size than the first size. The processor 114 is configured to capture the size of the physical contact area using the touchscreen 180 in conjunction with the contact/motion component 152. In this regard, the processor 114 may collect data over numerous interactions with the user and the touchscreen 180 and determine that the user has a particular physical contact area when interacting with the touchscreen 180. Again, the physical contact area not being limited to the users hand size, but including the physical contact area which includes the portion of the finger used by the user, bouncing of a finger, sliding a finger, use of a stylus, or the like. This registered contact area may be used to subsequently determine when a subsequent user of the electronic device 104 is a child.

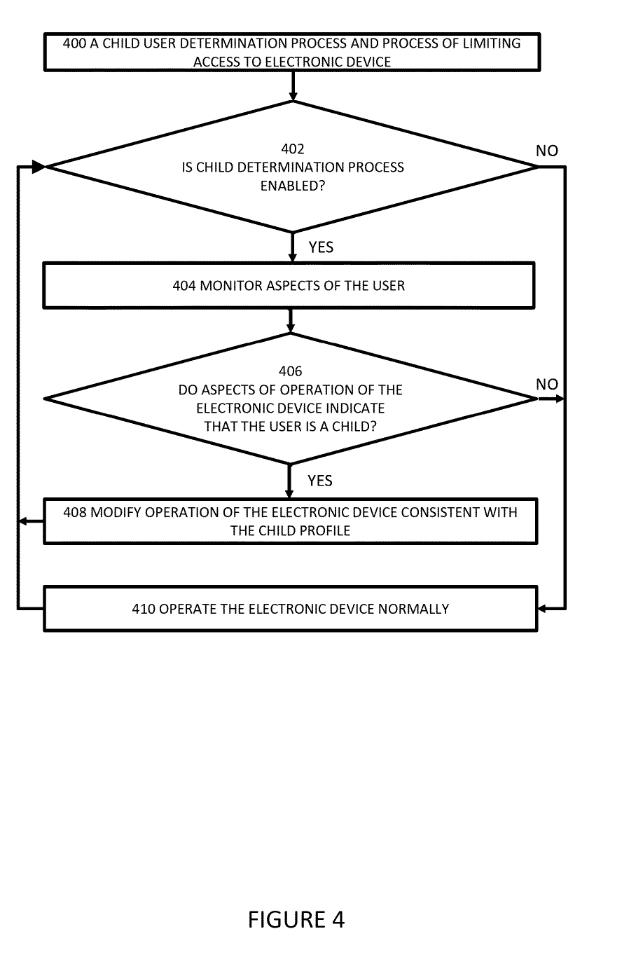

FIG. 4 shows a child user determination process and process of limiting access to an electronic device in accordance with aspects of the invention. In particular, FIG. 4 shows a child user determination process and process of limiting access to the electronic device 104. This process 400 may include an initial determination 402 whether or not the child determination process 400 is enabled. In this regard, the process 400 may be set by the factory to be initially enabled so that a user need not take any action in order to benefit from the process 400 operating. The electronic device 104 may include the ability to disable the process 400 if a user determines that they do not want to benefit from the process 400. On the other hand, the electronic device 104 may be set by the factory to be disabled. In that case, the user must take affirmative steps with the electronic device 104 in order to enable the process 400. Finally, the child user determination process and process of limiting access to electronic device 104 may be implemented as an application that is loaded onto the electronic device and/or downloaded from a website. When the process 400 is enabled, the process will move to process 404; and when the process is not enabled the process may advance to process 410.

In process 404, the electronic device 104 and the processor 114 may monitor various aspects of the user with respect to electronic device 104. For example, the electronic device 104 and processor 114 may monitor the size of the touch of the user, as described above, and determine the touch size for further implementation within process 400.

In a particular aspect, the size of the touch of the user may be previously measured based on an output of the touchscreen 180 and stored in the memory 116. After a predetermined number of measurements, the average size of the user's touch may be calculated in the processor 114. Thereafter, when a child with a smaller touch interacts with the touchscreen 180, the electronic device 104 may determine that the user is a child.

Additionally or alternatively, the process 404 may determine from the IMU 182 that the user is a child based on the handling of the electronic device 104 as described above. In particular, random movements, random orientations, shaking, and the like may be sensed by the IMU 182. If these actions exceed predetermined values and/or thresholds, the process 404 may determine that the present user is a child.

Finally, a user interacting with an application that is specific to a child's interest, the electronic device 104 and the processor 114 may determine that the user is a child. For example, an application related to the interests of a small child may be determinative of the user being a child. Other aspects are contemplated for monitoring as well such as those described below.

In process 406, the various aspects that were monitored in process 404 may be compared to particular thresholds. If the monitored aspects indicate that the user is a child (YES), the process 406 may advance to process 408. If on the other hand, the monitored aspects are indicative that the user is not child (NO), then the process 406 may advance to process 410. For example, if the monitored aspects are the size of touch of a user and the previously selected aspects of user touch size are substantially equivalent to the monitored size touch of a user, then the process will advance to process 410, and otherwise may advance to process 408. More specifically, the measured average size touch of the user determined in process 404 may be compared to a previously determined measured average size touch of the user. The previously determined average size touch of the user having been stored in memory 116. A predetermined variance or threshold may be included in the comparison process between the current determined size touch and the previous measured average size touch in order to prevent false positive determinations.

In process 408, the processor 114 may modify the operation of electronic device 104 to be consistent with a child user profile if it is determined in process 406 that the user is a child. In process 410, if the child determination process 400 was not enabled, as set forth in process 402, or the monitored aspects of user were not indicative of a child as set forth in process 406, then in process 410 the current operation of the electronic device will be allowed. Thereafter, the process will loop back to process 402.

After operation of the electronic device 104 has been modified in process 408 to be consistent with a child user profile, the process may loop back through process 402, 404, 406 to determine if the various monitored aspects are now indicative of a non-child user. If they are indicative of a non-child user, process 410 may be implemented to operate the electronic device in the normal fashion. In other words, once the electronic device 104 determines the user is a non-child user, the electronic device 104 operates normally.

Additionally, the process 400 may also include the ability for the user to operate the electronic device 104 with the child user profile 500 implemented without the need to determine that the user is a child. In this regard, process 406 may also determine whether the user of the electronic device 104 has been manually set for this implementation. In this regard, a user may know that they are going to allow a child to operate electronic device 104. With this knowledge, the adult user may set the child user profile 500 manually. Thereafter, they can allow the child to use the electronic device with the knowledge that the child user profile is being utilized by the electronic device 104. After the child returns the electronic device 104, the adult user can then manually disable the child user profile 500.

Process 400 may further include the ability for an adult user to override process 408 in the event that process 408 has been implemented. For example, if an adult user operates the electronic device 104 and process 400 and erroneously determined that the adult user is a child and limits usage of the electronic device 104 based on the child's profile, the adult user can proactively take steps to override this determination so as to not be limited to the child profile.

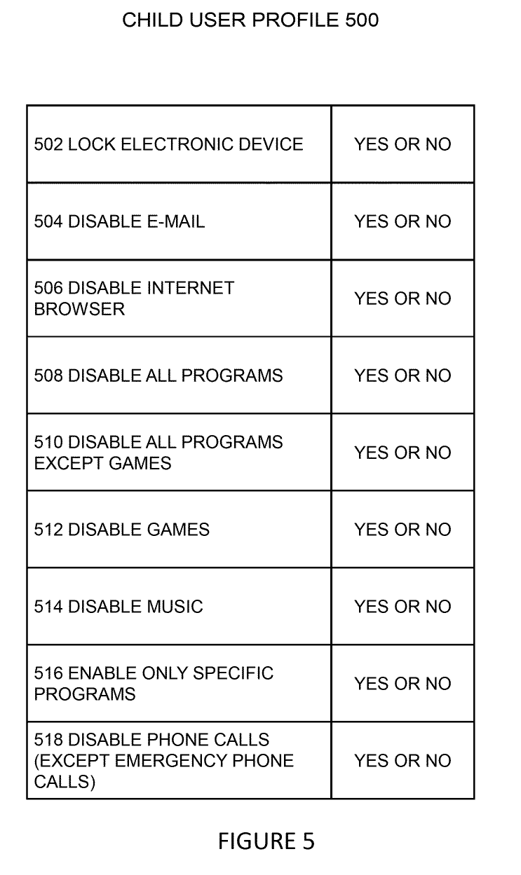

FIG. 5 shows a child user profile in accordance with aspects of the invention. In particular, when it is determined that the user is a child, the electronic device 104 may operate based on a child user profile 500 as described in conjunction with process 400. The child user profile 500 may modify operation of electronic device 104 on numerous different levels. However, if the electronic device 104 is a mobile phone, then the emergency call function may not be subject to limitations set forth by the child user profile 500 in order to maintain the ability for the electronic device 104 to make emergency calls.

Other than the emergency call feature, the child user profile 500 may include the ability to selectively limit operation of electronic device 104 to completely lock the electronic device 502. In this regard, the use of the electronic device 104 is completely limited except for the emergency call feature.

The child user profile 500 may include the ability to selectively disable e-mail 504. In this regard, the electronic device 104 may operate normally except that the ability to e-mail may be disabled.

The child user profile 500 may include the ability to selectively disable the Internet browser 506. In this regard, the electronic device 104 may operate normally except that the ability to utilize the Internet browser may be disabled.

The child user profile 500 may include the ability to selectively disable all programs 508. In this regard, the electronic device 104 may operate normally except that the ability to operate programs may be disabled.

The child user profile 500 may include the ability to selectively disable games 512. In this regard, the electronic device 104 may operate normally except that the ability to operate games may be disabled.

The child user profile 500 may include the ability to selectively disable music 514. In this regard, the electronic device 104 may operate normally except that the ability to play music may be disabled.

The child user profile 500 may include the ability to selectively enable only specific programs 516. In this regard, the electronic device 104 may be limited except that the ability to operate certain programs will be enabled.

The child user profile 500 may include the ability to selectively disable phone calls 518. In this regard, the electronic device 104 may operate normally except that the ability to place non-emergency phone calls may be disabled.

Additionally, the child user profile 500 may further include the ability to selectively enable or disable other functionalities of the electronic device 104 including reviewing photos, taking photos, adjusting settings, using online retail purchasing application, using online banking applications, and the like.

Additionally, the child user profile 500 may allow for more than one disabling feature to be selected. For example, e-mail may be disabled 504, Internet browser may be disabled 506, and use of the phone 518 (except emergency calls) may be disabled. Accordingly, the child user profile 500 may be fully customizable by the user in order to selectively limit features of the electronic device 104 as desired.

Accordingly, the system and process described above modifies operation of electronic devices based on the determination of whether the user of the electronic device is a child. The result is that when the user is a child, the electronic device may limit or prevent operation. Accordingly, the user of the electronic device may substantially prevent or limit undesired use of the electronic device by a child.

For the purposes of this disclosure a computer readable medium stores computer data, which data can include computer program code that is executable by a processor of the SIM or mobile device, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and nonremovable storage media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage media, magnetic cassettes, magnetic tape, magnetic disk storage or other magnetic storage devices, or any other physical or material medium which can be used to tangibly store the desired information or data or instructions and which can be accessed by a processor or computing device. In one or more aspects, the actions and/or events of a method, algorithm or module may reside as one or any combination or set of codes and/or instructions on a computer readable medium or machine readable medium, which may be incorporated into a computer program product.

The invention may include communication channels that may be any type of wired or wireless electronic communications network, such as, e.g., a wired/wireless local area network (LAN), a wired/wireless personal area network (PAN), a wired/wireless home area network (HAN), a wired/wireless wide area network (WAN), a campus network, a metropolitan network, an enterprise private network, a virtual private network (VPN), an internetwork, a backbone network (BBN), a global area network (GAN), the Internet, an intranet, an extranet, an overlay network, a cellular telephone network, a Personal Communications Service (PCS), using known protocols such as the Global System for Mobile Communications (GSM), CDMA (Code-Division Multiple Access), W-CDMA (Wideband Code-Division Multiple Access), Wireless Fidelity (Wi-Fi), Bluetooth, and/or the like, and/or a combination of two or more thereof.

In an embodiment, the invention may be implemented in any type of mobile smartphones that are operated by any type of advanced mobile data processing and communication operating system, such as, e.g., an Apple iOS operating system, a Google Android operating system, a RIM Blackberry operating system, a Nokia Symbian operating system, a Microsoft Windows Mobile operating system, a Microsoft Windows Phone operating system, a Linux operating system or the like.

Further in accordance with various aspects of the invention, the methods described herein are intended for operation with dedicated hardware implementations including, but not limited to, microprocessors, PCs, PDAs, SIM cards, semiconductors, application specific integrated circuits (ASIC), programmable logic arrays, cloud computing devices, and other hardware devices constructed to implement the methods described herein.

While the system and method have been described in terms of what are presently considered to be specific aspects, the disclosure need not be limited to the disclosed aspects. It is intended to cover various modifications and similar arrangements included within the spirit and scope of the claims, the scope of which should be accorded the broadest interpretation so as to encompass all such modifications and similar structures. The present disclosure includes any and all aspects of the following claims.

1. An electronic device configured to restrict access to features comprising:
a processor configured to execute instructions;
a display device configured to generate an interface based in part in response to the processor;
a touch screen associated with the display device and configured to sense a user input, wherein the input is provided to the processor;
a memory configured to store the instructions to operate the electronic device;
the processor further configured to determine at least one of a physical aspect of the user input and a user interaction with the electronic device;
the processor further configured to execute a plurality of features associated with the electronic device; and
the processor further configured to disable some of the features based on the determination of at least one of a physical aspect of the user input and a user interaction with the electronic device.

2. The electronic device according to claim 1 wherein the processor is further configured to enable, after some of the features being disabled, the features based on a subsequent determination of at least one of a physical aspect of the user input and a user interaction with the electronic device.

3. The electronic device according to claim 1 wherein the physical aspect of the user input determined by the processor comprises at least one of a physical contact area of the user with respect to the touchscreen and a manner in which the user contacts the touchscreen.

4. The electronic device according to claim 1 wherein the user interaction comprises movement of the electronic device.

5. The electronic device according to claim 1 wherein the user interaction comprises a manual implementation.

6. The electronic device according to claim 1 wherein the features that are disabled comprise at least one of e-mail, Internet browsing, playing games, playing music, placing phone calls, reviewing photos, taking photos, adjusting settings, using online retail purchasing applications, using online banking applications, and executing applications.

7. The electronic device according to claim 1 wherein the electronic device comprises at least one of a wireless phone, mobile phone, user equipment, MP3 player, gaming device, tablet computer, smartphone, and personal digital assistant.

8. The electronic device according to claim 1 wherein the processor is further configured to receive from the user the features that are to be disabled.

9. A process of restricting features of an electronic device comprising:
generating an interface on a display device of an electronic device;
sensing a user input on a touch screen associated with the display device and a user interaction with the electronic device;
storing instructions to operate the electronic device in a memory;
providing a plurality of features associated with the electronic device;
determining at least one of a physical aspect of the user input and a user interaction with the electronic device; and
disabling some of the features based on the determining at least one of a physical aspect of the user input and a user interaction with the electronic device.

10. The process according to claim 9 further comprising repeating the step of determining and enabling the features, after some of the features being disabled, based on at least one of a physical aspect of the user input and a user interaction with the electronic device.

11. The process according to claim 9 wherein determining at least one of a physical aspect of the user input comprises determining at least one of the physical contact area of the user with respect to the touchscreen and a manner in which the user contacts the touchscreen.

12. The process according to claim 9 wherein determining a user interaction with the electronic device comprises determining movement of the electronic device.

13. The process according to claim 9 wherein determining a user interaction with the electronic device comprises a manual implementation.

14. The process according to claim 9 the features that are disabled comprise at least one of e-mail, Internet browsing, playing games, playing music, placing phone calls, reviewing photos, taking photos, adjusting settings, using online retail purchasing applications, using online banking applications, and executing applications.

15. The process according to claim 9 wherein the electronic device comprises at least one of a wireless phone, mobile phone, user equipment, MP3 player, gaming device, tablet computer, smartphone, and personal digital assistant.

16. The process according to claim 9 further comprising receiving from the user the features that are to be disabled.

17. An electronic device configured to restrict access to features comprising:
means for generating an interface on a display device;
means for sensing a user input on a touch screen associated with the display device and a user interaction with the electronic device;
means for storing instructions to operate the electronic device in a memory;
means for providing a plurality of features associated with the electronic device;
means for determining at least one of a physical aspect of the user input and a user interaction with the electronic device; and
means for disabling some of the features based on the determining at least one of a physical aspect of the user input and a user interaction with the electronic device.

18. The electronic device according to claim 17 further comprising means for enabling the features, after some of the features being disabled, based on determining at least one of a physical aspect of the user input and a user interaction with the electronic device.

19. The electronic device according to claim 17 wherein the means for determining at least one of a physical aspect of the user input comprises determining at least one of the physical contact area of the user with respect to the touchscreen and a manner in which the user contacts the touchscreen.

20. The electronic device according to claim 17 wherein the means for determining a user interaction with the electronic device comprises determining movement of the electronic device.

21. The electronic device according to claim 17 wherein the means for determining a user interaction with the electronic device comprises a manual implementation.

22. The electronic device according to claim 17 the features that are disabled comprise at least one of e-mail, Internet browsing, playing games, playing music, placing phone calls, reviewing photos, taking photos, adjusting settings, using online retail purchasing applications, using online banking applications, and executing applications.

23. The electronic device according to claim 17 wherein the electronic device comprises at least one of a wireless phone, mobile phone, user equipment, MP3 player, gaming device, tablet computer, smartphone, and personal digital assistant.

24. The electronic device according to claim 17 further comprising means for receiving from the user the features that are to be disabled.
